(19) United States
(12) Patent Application Publication
(10) Pub. No.: US 2012/0235910 A1
(43) Pub. Date: Sep. 20, 2012

(54) Environmentally Sealed Controller

(75) Inventors: Gregory R. Wolfe, Royersford, PA (US); Warren G. Southard, Norristown, PA (US); Jeffrey Lyn Stitt, Levittown, PA (US)

(73) Assignee: AVO MULTI-AMP CORPORATION D/B/A MEGGER, Dallas, TX (US)

(21) Appl. No.: 13/049,538

(22) Filed: Mar. 16, 2011

(51) Int. Cl. G06F 3/033

(52) U.S. Cl. 345/161

(57) ABSTRACT

A test device is provided. The test device comprises a motion-sensing joystick and a pliable, substantially impermeable membrane coupled to the test device such that the joystick is sealed from at least one environmental contaminant.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Testing of transformers, generators, and other components of electrical power generation and distribution systems is sometimes conducted by connecting a test device to the components, exciting the windings and/or other internal elements of the components, and observing the results. Transporting a transformer, generator, or other component to a controlled test laboratory environment may not be logistically or economically feasible, and therefore testing typically occurs on site, often outdoors in variable weather conditions. As can readily be appreciated by one skilled in the power distribution art, the testing environment associated with high voltage power systems may be subject to inclement weather and high levels of humidity and/or airborne dust.

### SUMMARY

In an embodiment, a test device is provided. The test device comprises a motion-sensing joystick and a pliable, substantially impermeable membrane coupled to the test device such that the joystick is sealed from at least one environmental contaminant.

In another embodiment, a membrane for a test device is provided. The membrane comprises at least one portion molded in size and shape such that the membrane fits tightly over a joystick on the test device.

In another embodiment, a motion-sensing joystick on a test device is provided. The joystick comprises a pliable, substantially impermeable membrane coupled to the joystick such that the membrane fits tightly over the joystick and such that the joystick is sealed from at least one environmental contaminant.

These and other features and advantages will be more clearly understood from the following detailed description taken in conjunction with the accompanying drawings and claims.

### BRIEF DESCRIPTION OF THE DRAWINGS

FIG. 1 illustrates an example of a test device according to an embodiment of the present disclosure.

FIG. 2 is a close-up view of a joystick and other input mechanisms on a test device according to several embodiments of the present disclosure.

FIG. 3 illustrates a portion of a membrane that covers a joystick and other input mechanisms on a test device according to several embodiments of the present disclosure.

FIG. 4 illustrates a cross-section of a membrane that covers a joystick on a test device according to several embodiments of the present disclosure.

FIG. 5 illustrates a test device with a membrane removed from the joystick according to several embodiments of the present disclosure.

For a more complete understanding of the presentation and the advantages thereof, reference is now made to the following brief description, taken in connection with the accompanying drawings and detailed description, wherein like reference numerals represent like parts.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

Embodiments of the present disclosure provide a substantially impermeable seal for an electrical test device. More specifically, at least a portion of such a device is covered by a membrane that seals the device from the external environment such that dirt, humidity, and other possibly harmful external elements cannot reach a joystick and other components of the test device.

As used herein, the term “test device” refers to a device capable of performing tests on power system components such as, but not limited to, power system transformers, instrument transformers, cables, generators, electric motors, rotating machines, batteries, protection relays, circuit breakers, and other power system components. In an embodiment, a test device might include a stimulator component configured to output an electrical stimulus to a power system component that is under test. In an embodiment, a test device might also include a detector component configured to measure a response made by the power system component to the stimulus provided by the stimulator component. The stimulator component and the detector component will be further discussed below, and additional details regarding the stimulator component, the detector component, and other components of an embodiment of a test device can be found in US Patent Application Serial number 20090273336, “Upgradable Test Set”, which is incorporated herein by reference.

A test device may be self-contained within a single case and may be ruggedized and shielded appropriately to provide service in the harsh electrical environment of a power generation and/or power distribution location. A test device may be controlled using one or more input components, such as a joystick and push buttons, and test results may be displayed on a display component.

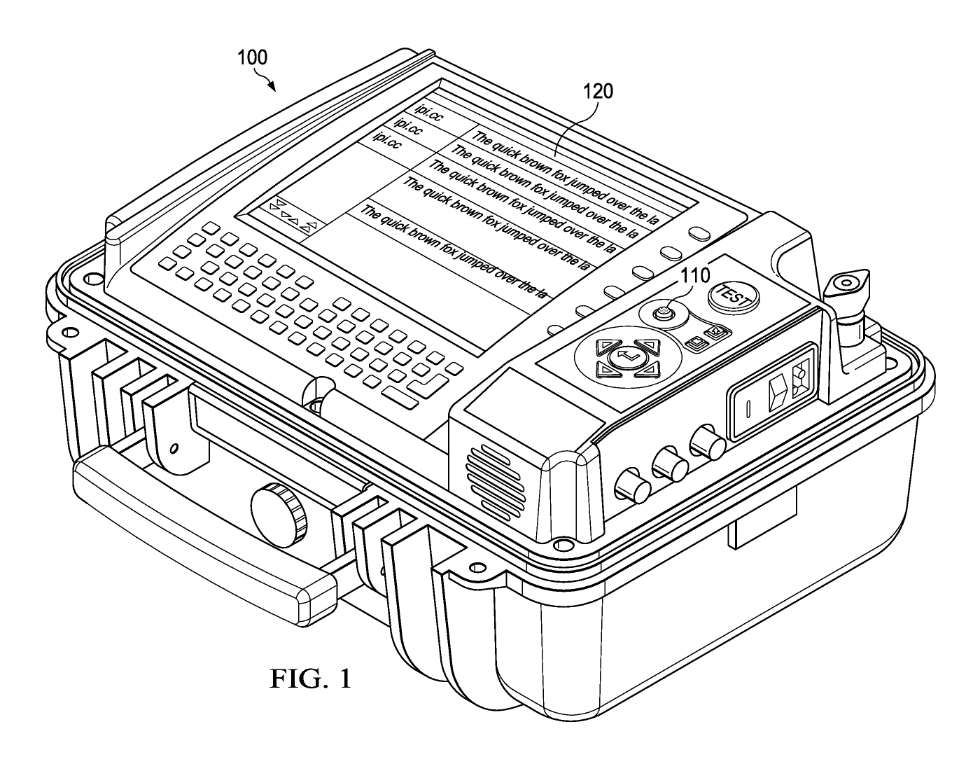

FIG. 1 illustrates an example of a test device 100 that might be used in various embodiments of the disclosure. Among the input components on the test device 100 is a joystick 110. The joystick 110 might be used to control the movement of a cursor or mouse pointer on a display screen 120 on the test device 100 or might be used to generate some other type of input into the test device 100.

In general, joysticks may be categorized as either motion-sensing joysticks or force-sensing joysticks. With a force-sensing joystick, a user presses a surface on or near the joystick. The joystick measures how much force is being applied to the surface and where the force is being applied. The amount and location of the applied force corresponds to the input generated by the joystick. With a motion-sensing joystick, the user physically deflects the joystick rather than merely pressing on or near it. That is, a lower portion of the joystick acts as a stationary pivot around which an upper portion might move. A movement of the upper portion in some direction over some distance, usually a few millimeters, corresponds to the input generated by the joystick.

As mentioned above, the test device 100 might sometimes be used in a harsh environment that might call for the use of gloves or other protective equipment on the part of the device operator. An operator wearing gloves who tries to manipulate a force-sensing joystick might have difficulty in producing the necessary level of fine control over the amount and location of the force applied to such a joystick. That is, the operator might inadvertently apply force to an area where application of force was not intended, thus causing an unintended input. With a motion-sensing joystick, on the other hand, an operator is much more likely to be able to provide the desired input, even when wearing gloves. Therefore, in an embodiment, the joystick 110 on the test device 100 is a motion-sensing joystick rather than a force-sensing joystick.

In an embodiment, the joystick 110 is covered by a pliable membrane that is substantially impermeable to moisture and commonly encountered solid, liquid or gaseous environmental contaminants. As used herein, the term “substantially impermeable” refers to a capability to generally prevent or slow the passage of materials that are likely to be present in commonly encountered environments. The membrane might be made of rubber, polypropylene, polyethylene, or other materials that are similarly pliable and impermeable. The membrane adheres to the joystick 110 and to at least a portion of the surface of the test device 100 surrounding the joystick 110. The seal between the membrane and the joystick 110 and its surrounding surface is provided in order to prevent any solid, liquid or gas from reaching the joystick 110. In this way, the joystick 110 can function properly in harsh environments without interference from contaminants.

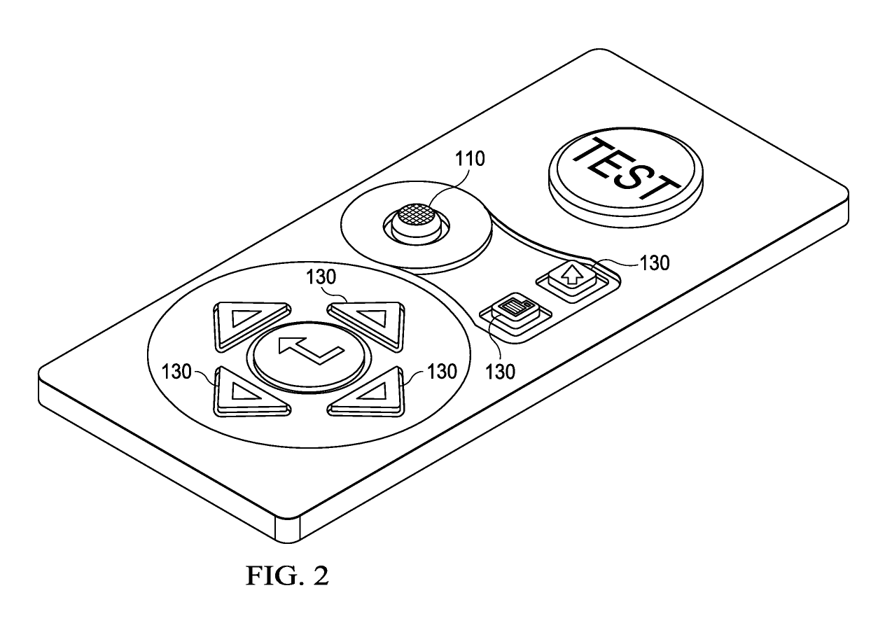

In an embodiment, the membrane that covers the joystick 110 also substantially impermeably covers at least one other input mechanism, such as a push button, on the test device 100. This is illustrated in FIG. 2, where a close-up view of the joystick 110 is shown. In this example, a single membrane covers the joystick 110 and a plurality of push buttons 130. The membrane is molded to the joystick 110 and the buttons 130 and adheres to a lower surface surrounding the joystick 110 and the buttons 130 such that a user cannot readily lift the membrane away from the joystick 110 and the buttons 130.

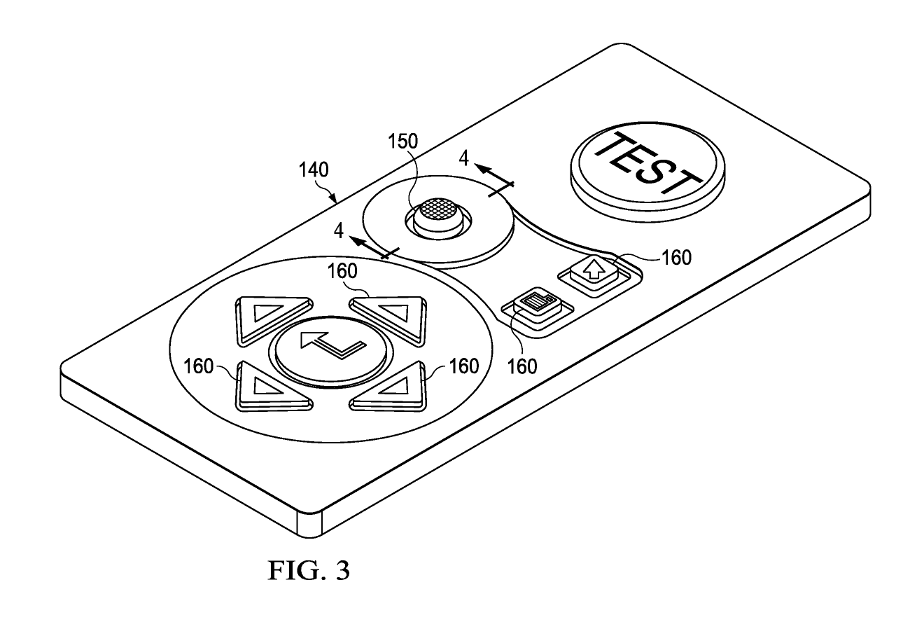

FIG. 3 illustrates an embodiment of at least a portion of a membrane 140 that might provide a substantially impermeable seal over the joystick 110. The membrane 140 includes a joystick portion 150 that is molded to the size and shape of the upper portion of the joystick 110 such that the joystick portion 150 fits over the upper portion of the joystick 110. The membrane 140 includes a plurality of other portions 160 that are molded to the size and shape of the buttons 130. If input mechanisms other than the buttons 130 were present near the joystick 110, the other portions 160 would have sizes and shapes appropriate for those input mechanisms. It can be seen that the membrane 140 extends over an area considerably larger than the joystick 110, thus providing additional protection for the joystick 110 against the ingress of environmental contaminants.

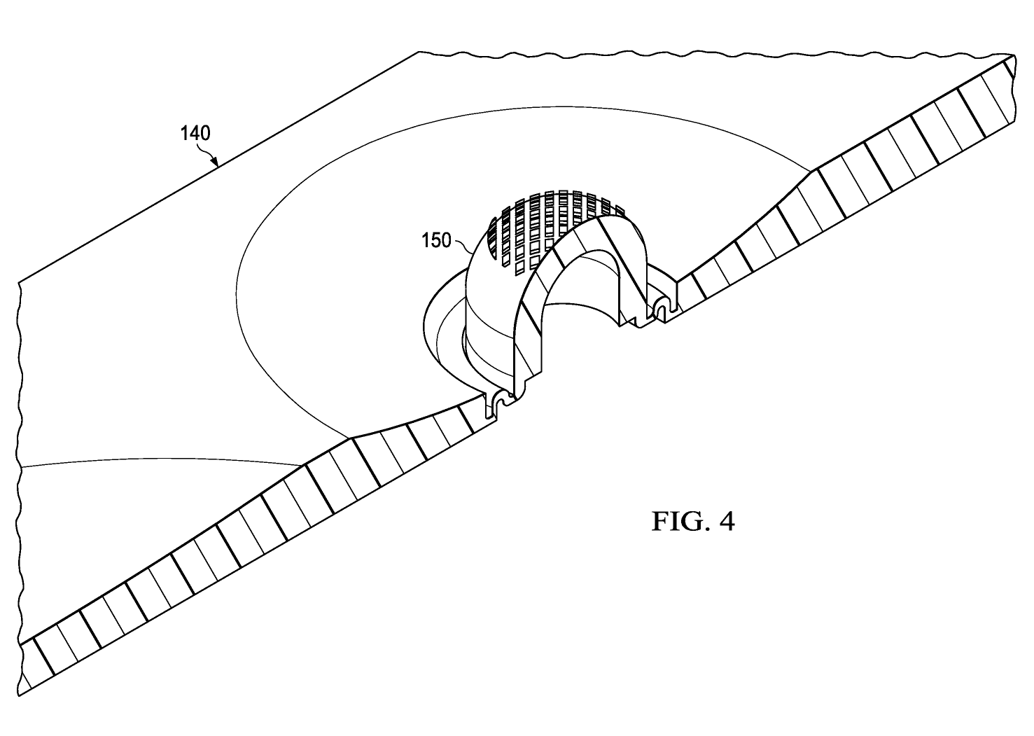

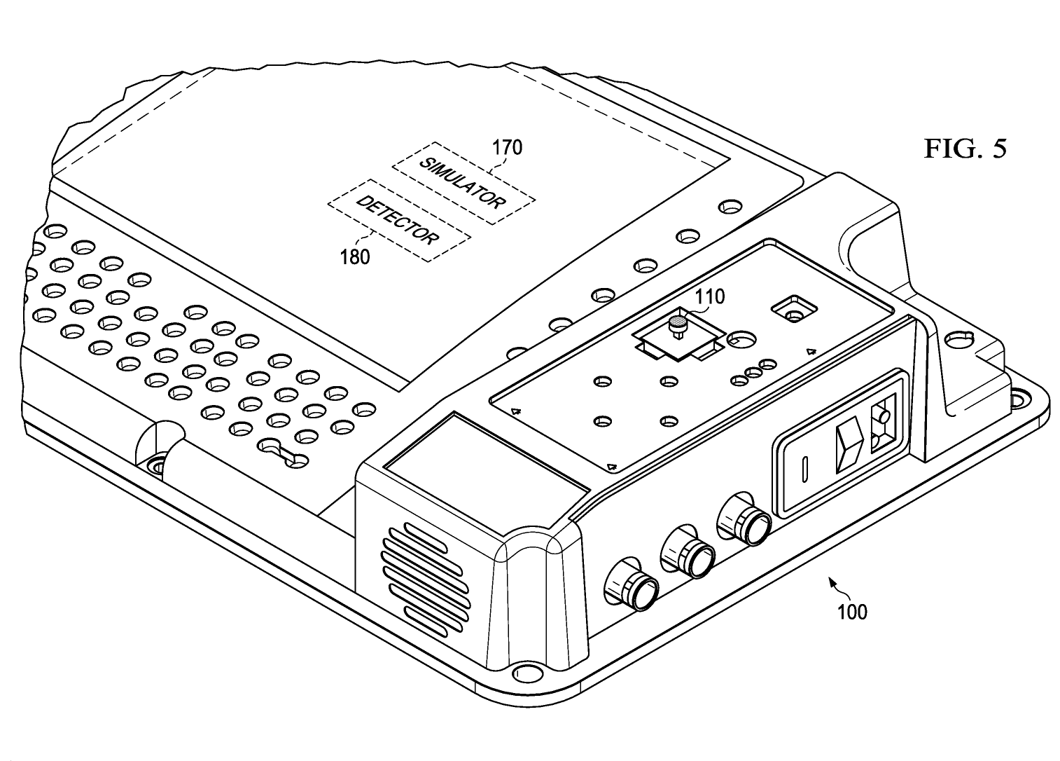

FIG. 4 illustrates a cross-section of a portion of the membrane 140, and FIG. 5 illustrates a portion the test device 100 with the membrane 140 removed. It can be seen that the portion 150 of the membrane 140 that covers the joystick 110 has a shape and size that matches the shape and size of the upper portion of the joystick 110. When the membrane 140 is sealed to the joystick 110, the portion 150 of the membrane 140 that covers the joystick 110 conforms to the joystick 110. Thus, as used herein, the term “joystick” might refer to either the bare joystick 110, as illustrated in FIG. 5, or to a bare joystick covered by the membrane 140, as illustrated in FIGS. 1 and 2.

Also shown in FIG. 5 are a stimulator component 170 and a detector component 180 of the test device 100. The stimulator component 170 outputs a stimulus into a power system component for use in testing the power system component. The detector component 180 may then sense the response by the power system component to the application of the stimulus. The test device 100 may then process and/or analyze measurements taken by the detector component 180. The measurements may include, for example, applied current and voltage drop across the windings of the power system component.

The detector component 180 may include one or more analog-to-digital converters to capture the voltage and/or current of an output of the power system component. In an embodiment, the detector component 180 may include other circuitry or processing functionality to analyze the captured response and determine a test result parameter, such as a resistance or impedance of a winding, an impedance of a transformer insulation, a dissipation factor of the transformer insulation, an insulation power factor of the transformer insulation, a capacitance of the transformer insulation, a permittivity of the transformer insulation, a susceptibility of the transformer insulation, a dissipation factor, insulation power factor, capacitance, permittivity, and/or susceptibility of the power system component, and other parameter values. Alternatively, in another embodiment, the detector component 180 provides unprocessed data to the test device 100, and the test device 100 analyzes the unprocessed data to determine the test result parameter. For example, the detector component 180 may provide data pairs of voltage value and current value to the test device 100, and the test device 100 may analyze this data to determine the related parameter values.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A test device, comprising:
a motion-sensing joystick; and
a pliable, substantially impermeable membrane coupled to the test device such that the joystick is sealed from at least one environmental contaminant.

2. The test device of claim 1, wherein the membrane seals from the at least one environmental contaminant at least one input mechanism on the test device in addition to the joystick.

3. The test device of claim 2, wherein the membrane is molded in size and shape such that the membrane fits tightly over the joystick and the at least one additional input mechanism.

4. The test device of claim 1, wherein the membrane is coupled to a surface of the test device by an adhesive.

5. The test device of claim 1, wherein the environmental contaminant is at least one of:
dust; and
moisture.

6. The test device of claim 1, wherein the membrane is made of at least one of:
rubber;
polypropylene; and
polyethylene.

7. A membrane for a test device, comprising:
at least one portion molded in size and shape such that the membrane fits tightly over a joystick on the test device.

8. The membrane of claim 7, wherein the membrane is a pliable, substantially impermeable material couplable to the test device such that the joystick is sealed from at least one environmental contaminant.

9. The membrane of claim 8, wherein the membrane is coupled to a surface of the test device by an adhesive.

10. The membrane of claim 8, wherein the membrane is molded in size and shape such that the membrane fits tightly over at least one input mechanism on the test device in addition to the joystick and such that the membrane seals from the at least one environmental contaminant the at least one additional input mechanism.

11. The membrane of claim 8, wherein the environmental contaminant is at least one of:
dust; and
moisture.

12. The membrane of claim 7, wherein the membrane is made of at least one of:
rubber;
polypropylene; and
polyethylene.

13. The membrane of claim 7, wherein the joystick is a motion-sensing joystick.

14. A motion-sensing joystick on a test device, comprising:
a pliable, substantially impermeable membrane coupled to the joystick such that the membrane fits tightly over the joystick and such that the joystick is sealed from at least one environmental contaminant.

15. The joystick of claim 14, wherein the membrane is molded in size and shape such that the membrane fits tightly over at least one input mechanism on the test device in addition to the joystick and such that the membrane seals from the at least one environmental contaminant the at least one additional input mechanism.

16. The joystick of claim 14, wherein the membrane is coupled to a surface of the test device by an adhesive.

17. The joystick of claim 14, wherein the environmental contaminant is at least one of:
dust; and
moisture.

18. The joystick of claim 14, wherein the membrane is made of at least one of:
rubber;
polypropylene; and
polyethylene.
